(19) United States
(12) Patent Application Publication
(10) Pub. No.: US 2012/0033670 A1
(43) Pub. Date: Feb. 9, 2012

(54) EGRESS PROCESSING OF INGRESS VLAN ACLs

(75) Inventor: Joseph F. Olakangil, San Jose, CA (US)

(73) Assignee: Alcatel-Lucent, USA Inc., Murray Hill, NJ (US)

(21) Appl. No.: 13/196,782

(22) Filed: Aug. 2, 2011

Related U.S. Application Data
(60) Provisional application No. 61/371,254, filed on Aug. 6, 2010.

(51) Int. Cl. H04L 12/56

(52) U.S. Cl. 370/392

(57) ABSTRACT

A network packet processing system includes source and destination virtual local area networks (VLANs) that are indirectly connected through a network routing device. Additionally, the network packet processing system includes a metadata generator connected to provide metadata for a network packet to be routed between the source and destination VLANS, wherein the metadata captures pre-routing source VLAN information from the network packet. The network packet processing system also includes an access control list (ACL) for specifying routing of the network packet between the source and destination VLANs that employs the pre-routing source VLAN information from the metadata and post-routing destination VLAN information from the network packet. A method of network packet processing is also included.

### CROSS-REFERENCE TO RELATED APPLICATION

This application claims the benefit of U.S. Provisional Application Ser. No. 61/371,254, filed by Joseph F. Olakangil on Aug. 6, 2010, entitled “Egress Processing Of Ingress VLAN ACLS” commonly assigned with this application and incorporated herein by reference.

### TECHNICAL FIELD

This application is directed, in general, to virtual local area networks and, more specifically, to a network packet processing system and a method of network packet processing.

### BACKGROUND

A virtual local area network (VLAN) is typically a group of local area networks (LANs) having a common set of requirements that communicate as if they were attached to the same broadcast domain, regardless of their physical location. Some VLANs may be able to communicate directly with another common VLAN, but are unable to communicate directly with each other. For example, engineering and customer support VLANs may each be able to route traffic to an Internet VLAN, while being unable to route traffic directly between them.

The configuration of a VLAN may be essentially performed in software using access control lists (ACLs), which can provide packet filtering and traffic flow control. Users would like to implement access controls between VLANs in a simple fashion of being able to specify a policy that controls traffic between specific source and destination VLANs. However, the source VLAN is available only in the pre-routing lookup stage, and the destination VLAN is available only in the post-routing lookup stage. So, a way to bridge these disparate pieces of information in implementing an ACL would prove beneficial to the art.

### SUMMARY

Embodiments of the present disclosure provide a network packet processing system and a method of network packet processing. In one embodiment, the network packet processing system includes source and destination virtual local area networks (VLANs) that are indirectly connected through a network routing device. Additionally, the network packet processing system includes a metadata generator connected to provide metadata for a network packet to be routed between the source and destination VLANS, wherein the metadata captures pre-routing source VLAN information from the network packet. The network packet processing system also includes an access control list (ACL) for specifying routing of the network packet between the source and destination VLANs that employs the pre-routing source VLAN information from the metadata and post-routing destination VLAN information from the network packet.

In another aspect, the method of network packet processing includes providing indirectly linked source and destination virtual local area networks (VLANs) that are connected through a network routing device and defining an access control list (ACL) specifying network traffic between the source and destination VLANs. The method also includes generating metadata for a network packet to be routed between the source and destination VLANS, wherein the metadata captures pre-routing source VLAN information from the network packet. The method further includes applying the ACL for routing the network packet employing the pre-routing source VLAN information from the metadata and post-routing destination VLAN information from the network packet.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

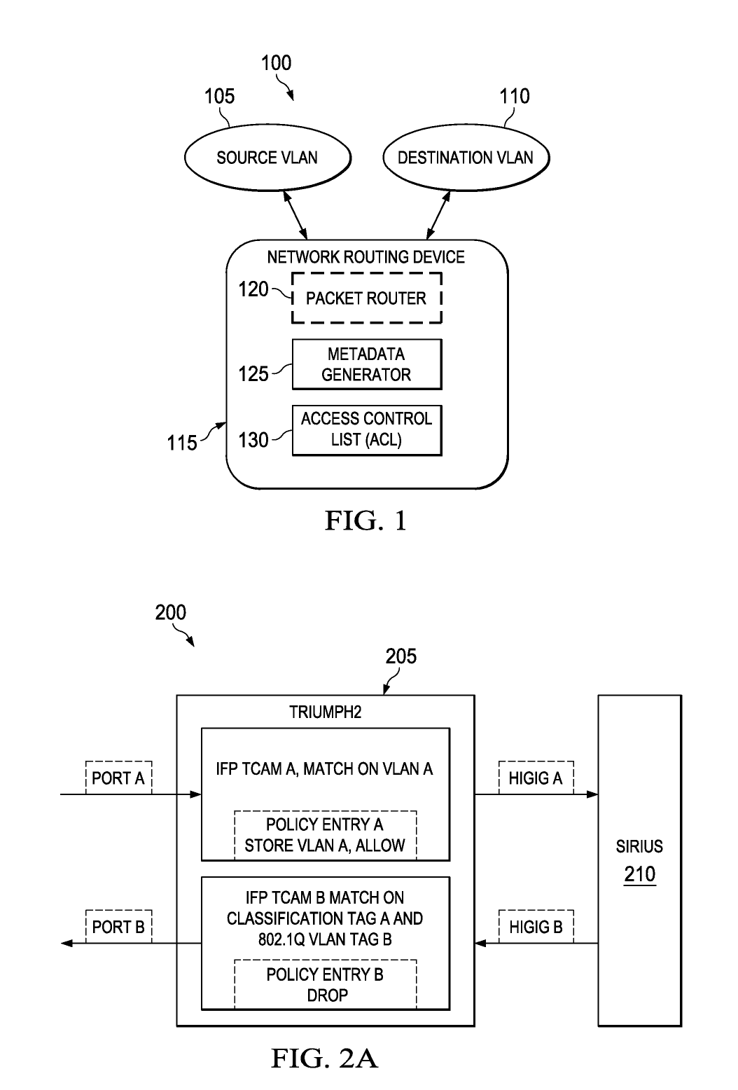

FIG. 1 illustrates a block diagram of an embodiment of a network packet processing system constructed according to the principles of the present disclosure;

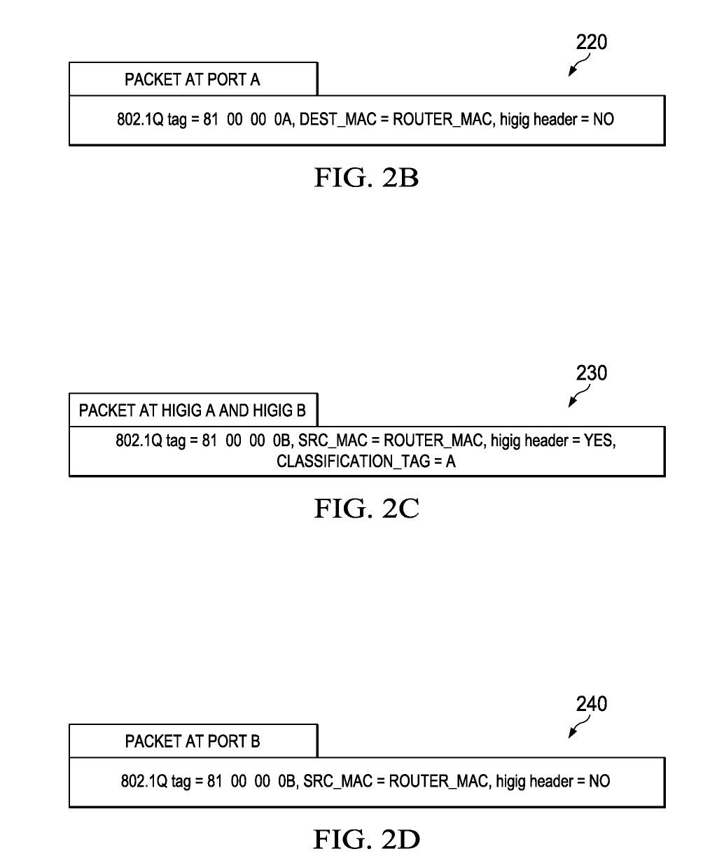

FIGS. 2A, 2B, 2C and 2D illustrate selected examples of a routing embodiment as may be employed in the network packet processing system of FIG. 1.

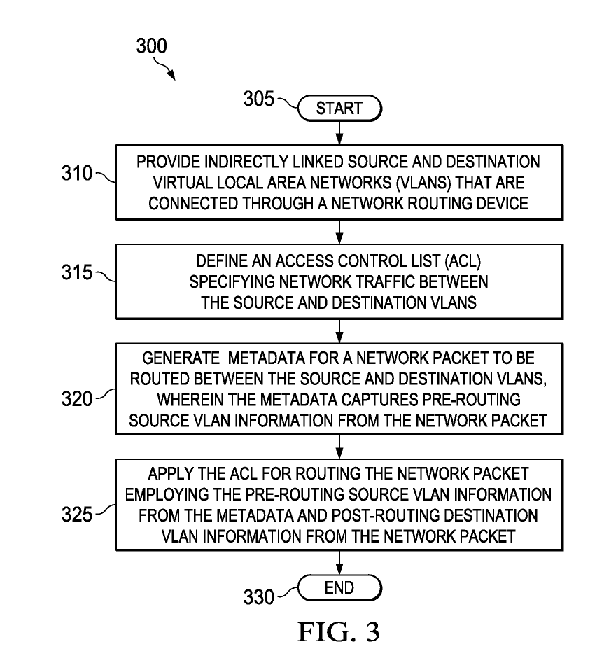

FIG. 3 illustrates a flow diagram of an embodiment of a method of network packet processing carried out according to the principles of the present disclosure.

### DETAILED DESCRIPTION

Embodiments of the present disclosure provide a user with the capability to implement access control between virtual local area networks (VLANs) in a more simple way, which is independent of the IP subnet of a VLAN or the IP addresses in a network packet, both of which are much more varied in range and harder to predict. Additionally, the user does not need to be aware of the IP addresses the VLANs or the users are communicating on when configuring the ACLs, thereby allowing for a more practical and stable user configuration.

FIG. 1 illustrates a block diagram of an embodiment of a network packet processing system, generally designated 100, constructed according to the principles of the present disclosure. The network packet processing system 100 includes source and destination virtual local area networks (VLANs) 105, 110 and a network routing device 115. Generally, the network routing device 115 may be a router or a switch having routing capability where either may be part of an interconnecting VLAN. In the illustrated embodiment, the network routing device 115 is a switch having routing capability and includes a packet router 120, a metadata generator 125 and an access control list (ACL) 130.

The source and destination VLANs 105, 110 are indirectly connected through the network routing device 115. The packet router 120 is employed to rout network packets within the network routing device 115. Although not directly shown, the network routing device 115 may be connected to other routing devices or VLANs. The metadata generator 125 is connected to provide metadata for a network packet to be routed between the source and destination VLANS 105, 110, wherein the metadata captures pre-routing source VLAN information from the network packet. The ACL 130 specifies routing of the network packet between the source and destination VLANs 105, 110, wherein the pre-routing source VLAN information from the metadata and post-routing destination VLAN information from the network packet are employed.

Embodiments of the present disclosure provide a solution for the source VLAN being available only in a pre-routing lookup stage, and the destination VLAN being available only in a post-routing lookup stage. The pre-routing lookup stage may typically include a VLAN assignment stage, an OSI layer two lookup stage and a classification stage before a routing lookup stage. The post-routing lookup stage occurs after packet routing is accomplished and involves where to send the network packet (e.g., the egress port to be employed, the destination VLAN to be employed, etc.).

In the illustrated embodiment, the network packet, which may be an internet protocol (IP) packet, ingresses from the source VLAN 105 that is represented by an ingress VLAN ID (identification number), and egresses to the destination VLAN 110 that is represented by an egress VLAN ID. In a VLAN conforming to the IEEE 802.1Q specification, a VLAN ID is a number between one and 4094. The metadata is additional packet data that is carried along with the network packet to make appropriate decisions about the network packet during its lifecycle within the network routing device 115. It is not information that enters or leaves with the network packet when it ingresses and egresses the network routing device 115.

The metadata may be included in an additional header that is mapped onto the packet. In one example, a header called a HiGig header employed in a Broadcom ASIC (application specific integrated circuit) is used to map the metadata onto the network packet as it is traversing the network routing device 115.

The HiGig header employs a 13 bit field classification tag that is basically a field in the HiGig header where the ingress VLAN ID may be stored. All network packets traverse the HiGig with an 802.1Q VLAN tag attached as part of the VLAN standard. This VLAN tag essentially adds the egress VLAN on the network routing device 115 (or a VLAN) that the network packet is a member of at that point in time. The VLAN tag employs a length of four bytes.

The packet router 120 includes a packet processor that takes the packet and performs a VLAN assignment (i.e., assigns a VLAN to the packet), looks up a layer for routing, does other classification of policy on the packet in terms of ACLs, does the routing on the packet and finally defines the egress port on an egress VLAN for switching the packet out of that port. The packet processor basically makes the modifications that have to happen on the packet by making switching and routing decisions on the packet.

The packet processor looks at the metadata and employs egress policies (ACLs) that can be applied to the network packet such as the ACL 130. In this specific case, metadata is being examined to extract the ingress (source) VLAN information and the destination VLAN is being determined from the network packet while applying these ACL policies on the packet processor.

FIGS. 2A, 2B, 2C and 2D illustrate selected examples of a routing embodiment, generally designated 200, 220, 230 and 240 as may be employed in the network packet processing system of FIG. 1. In FIG. 2A, a packet processor 205 employs a Triumph/Scorpion processor, and a queuing engine and switching fabric 210 employs a SIRIUS chip. All network packets are routed (switched) from the packet processor 205 to the queuing engine and switching fabric 210 over HiGig ports A, B and back to the packet processor 205.

The packets traverse the HiGig ports A, B encapsulated in a HiGig header. A TCAM (ternary content addressable memory) entry A provides a match on a source VLAN and stores the ingress VLAN ID of the source VLAN from which the network packet ingresses in a HiGig header classification tag field. The entry operates only on the input and output ports (i.e., front panel ports) of the packet processor and does not take effect on packets ingressing from the HiGig port.

The TCAM entry A matches on the classification tag value A and an egress VLAN ID B stored in the 802.1Q VLAN tag of the network packet. A TCAM entry B attempts to match only packets ingressing on the HiGig port B from the queuing engine and switching fabric 210. A policy entry B associated with the TCAM entry B then allows or drops the traffic based on previously defined ACLs.

FIGS. 2B, 2C and 2D illustrate examples of a TCAM entry configuration required to match a network packet at various processing stages. For a network packet at port A (FIG. 2B), the required TCAM entry configuration depicts the TCAM keys and values required to match the network packet on ingress. For a network packet at HiGig ports A and B (FIG. 2C), the required TCAM entry configuration depicts the TCAM keys and values required to match the network packet on egress. For a network packet at port B (FIG. 2D), the required TCAM entry configuration depicts the TCAM key and value when matching the packets on egress.

FIG. 3 illustrates a flow diagram of an embodiment of a method of network packet processing, generally designated 300, and carried out according to the principles of the present disclosure. The method 300 starts in a step 305 and indirectly linked source and destination virtual local area networks (VLANs) are provided that are connected through a network routing device, in a step 310. Then, in a step 315, an access control list (ACL) is defined specifying network traffic between the source and destination VLANs.

Metadata is generated for a network packet to be routed between the source and destination VLANS, wherein the metadata captures pre-routing source VLAN information from the network packet, in a step 320. The ACL for routing the network packet is applied employing the pre-routing source VLAN information from the metadata and post-routing destination VLAN information from the network packet, in a step 325.

In one embodiment, the network packet is an internet protocol (IP) packet. In another embodiment, the metadata is included in an additional header that is mapped onto the packet. In one example, the additional header is a HiGig header. In yet another embodiment, the metadata exists for at least a portion of an ingress-to-egress period of the network packet. In an additional embodiment, the metadata and the ACL conform to the IEEE 802.1Q specification.

In still another embodiment, the pre-routing source and post-routing destination VLAN information includes respective source and destination VLAN identification (ID) numbers. The source VLAN ID number is stored in a classification tag of a HiGig header, and the destination VLAN ID number is stored in a VLAN tag. The source and destination VLAN ID numbers range from one to 4094. The method 300 ends in a step 330.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Generally, these approaches or methodologies may also be expanded to cover other scenarios where mutually exclusive ingress and egress information on a network packet need to be coalesced. For example, these approaches may be applied to a source VLAN and an egress port or a source VLAN and a destination MAC. That is, they may be used to combine input information with output information anytime that a network packet can undergo modification during its lifecycle in a network routing device or a VLAN.

Those skilled in the art to which this application relates will appreciate that other and further additions, deletions, substitutions and modifications may be made to the described embodiments.

What is claimed is:

1. A method of network packet processing, comprising:
providing indirectly linked source and destination virtual local area networks (VLANs) that are connected through a network routing device;
defining an access control list (ACL) specifying network traffic between the source and destination VLANs;
generating metadata for a network packet to be routed between the source and destination VLANS, wherein the metadata captures pre-routing source VLAN information from the network packet; and
applying the ACL for routing the network packet employing the pre-routing source VLAN information from the metadata and post-routing destination VLAN information from the network packet.

2. The method as recited in claim 1 wherein the network packet is an internet protocol (IP) packet.

3. The method as recited in claim 1 wherein the metadata is included in an additional header that is mapped onto the packet.

4. The method as recited in claim 3 wherein the additional header is a HiGig header.

5. The method as recited in claim 1 wherein the metadata exists for at least a portion of an ingress-to-egress period of the network packet.

6. The method as recited in claim 1 wherein the pre-routing source and post-routing destination VLAN information includes respective source and destination VLAN identification (ID) numbers.

7. The method as recited in claim 6 wherein the source VLAN ID number is stored in a classification tag of a HiGig header.

8. The method as recited in claim 6 wherein the destination VLAN ID number is stored in a VLAN tag.

9. The method as recited in claim 6 wherein the source and destination VLAN ID numbers range from one to 4094.

10. The method as recited in claim 1 wherein the metadata and the ACL conform to the IEEE 802.1Q specification.

11. A network packet processing system, comprising:
source and destination virtual local area networks (VLANs) that are indirectly connected through a network routing device;
a metadata generator connected to provide metadata for a network packet to be routed between the source and destination VLANS, wherein the metadata captures pre-routing source VLAN information from the network packet; and
an access control list (ACL) for specifying routing of the network packet between the source and destination VLANs that employs the pre-routing source VLAN information from the metadata and post-routing destination VLAN information from the network packet.

12. The system as recited in claim 11 wherein the network packet is an internet protocol (IP) packet.

13. The system as recited in claim 11 wherein the metadata is included in an additional header that is mapped onto the packet.

14. The system as recited in claim 13 wherein the additional header is a HiGig header.

15. The system as recited in claim 11 wherein the metadata exists for at least a portion of an ingress-to-egress period of the network packet.

16. The system as recited in claim 11 wherein the pre-routing source and post-routing destination VLAN information includes respective source and destination VLAN identification (ID) numbers.

17. The system as recited in claim 16 wherein the source VLAN ID number is stored in a classification tag of a HiGig header.

18. The system as recited in claim 16 wherein the destination VLAN ID number is stored in a VLAN tag.

19. The system as recited in claim 16 wherein the source and destination VLAN ID numbers range from one to 4094.

20. The system as recited in claim 11 wherein the metadata and the ACL conform to the IEEE 802.1Q specification.
